(19) United States
(12) Patent Application Publication
(10) Pub. No.: US 2022/0371334 A1
(43) Pub. Date: Nov. 24, 2022

(54) IMAGE FORMATION WITH ELECTROSTATIC AND MOLECULAR FIXATION

(71) Applicant: Hewlett-Packard Development Company, L.P., Spring (US)

(72) Inventors: Omer Gila, Palo Alto, CA (US); Rajesh Kelekar, Palo Alto, CA (US); Napoleon J Leoni, Palo Alto, CA (US)

(73) Assignee: Hewlett-Packard Development Company, L.P., Spring, TX (US)

(21) Appl. No.: 17/259,808

(22) PCT Filed: Sep. 12, 2018
(86) PCT No.: PCT/US2018/050696

§ 371 Date: Jan. 12, 2021

(51) Int. Cl. B41J 2/215; B41J 2/08; B41M 5/50; B41M 7/00

(52) U.S. Cl. CPC B41J 2/215; B41J 2/08; B41M 5/502; B41M 7/0072

(57) ABSTRACT

An image formation device includes a first portion and a second portion. The first portion along a travel path is to receive droplets of color ink particles within a dielectric carrier fluid onto a substrate to form an image. The second portion includes a charge source to emit airborne charges to charge the color ink particles to move, via attraction relative to the substrate, through the carrier fluid to become electrostatically fixed relative to the substrate and to become additionally fixed, in their electrostatically fixed position, via distance-dependent, molecular forces relative to the substrate. The duration of additional fixation via distance-dependent, molecular forces may be at least greater than a duration of the electrostatic fixation.

### BACKGROUND

Modern printing techniques involve a wide variety of media, whether rigid or flexible, and for a wide range of purposes.

### BRIEF DESCRIPTION OF THE DRAWINGS

FIG. 1A is a diagram including a side view schematically representing an example image formation device and/or method of image formation.

FIG. 1B is a diagram including a side view schematically representing an example receiving portion for a fluid ejection device.

FIG. 1C is a diagram including a side view schematically representing an example fluid ejection device removably inserted relative to an example receiving portion for a fluid ejection device.

FIGS. 2A-2D are a series of diagrams each including a side view schematically representing example electrostatic fixation and/or molecular fixation of a charged ink particle relative to a substrate.

FIG. 3 is a diagram including a side view schematically representing an example image formation device and/or example method of image formation.

FIG. 4A is a block diagram schematically representing an example mechanical element for an example liquid removal portion.

FIG. 4B is a block diagram schematically representing an example energy transfer mechanism.

FIG. 5 is a diagram including a side view schematically representing an example image formation device and/or example method of image formation.

FIGS. 6A and 6B are each a diagram including a side view schematically representing an example transfer member and an example developer unit of an example image formation device and/or example method of image formation.

FIG. 6C is a diagram including a side view schematically representing an example developer unit removably inserted into an example receiving portion and/or at least some aspects of an example method of image formation.

FIG. 7A is a diagram including a side view schematically representing an example image formation device and/or method of image formation.

FIG. 7B is a diagram including a side view schematically representing an example image formation medium assembly.

FIG. 7C is a diagram 620 including a side view schematically representing example electrostatic fixation and/or molecular fixation of a charged color ink particle relative to a substrate.

FIG. 8 is a diagram including a side view schematically representing an example image formation device and/or method of image formation.

FIG. 9 is a diagram including a side view schematically representing an example image formation device and/or method of image formation including multiple stations for multiple color inks.

FIGS. 10 and 11 are each a block diagram schematically representing an example control portion and an example user interface, respectively.

FIG. 12 is a flow diagram schematically representing an example method of image formation.

### DETAILED DESCRIPTION

In the following detailed description, reference is made to the accompanying drawings which form a part hereof, and in which is shown by way of illustration specific examples in which the disclosure may be practiced. It is to be understood that other examples may be utilized and structural or logical changes may be made without departing from the scope of the present disclosure. The following detailed description, therefore, is not to be taken in a limiting sense, and the scope of the present disclosure is defined by the appended claims. It is to be understood that features of the various examples described herein may be combined, in part or whole, with each other, unless specifically noted otherwise.

In some examples, an image formation device comprises a first portion and a second portion. The first portion, along a travel path of a substrate, is to receive droplets of ink particles within a dielectric carrier fluid onto the substrate to form an image. In some examples, the ink particles comprise color ink particles. In some such examples, the ink particles may have having a conductivity of at least 500 pS/cm. Additional example conductivities for the ink particles are further described below.

The second portion is downstream along the travel path from the first portion and comprises a charge source to emit airborne charges to charge the color ink particles to move, via electrostatic attraction relative to the substrate, through the carrier fluid to become electrostatically fixed relative to the substrate and to become molecularly fixed, in their electrostatically fixed position, relative to the substrate. In some examples, the ink particles may be molecularly fixed for a duration at least greater than a duration of the electrostatic fixation. In some examples, the molecular fixation comprises a fixation implemented via distance-dependent molecular attraction forces. In some examples, the distance-dependent, molecular attraction forces may comprise forces such as van der Waals forces and covalent bonds.

In some examples, the electrostatic fixation and/or molecular fixation is at least partially implemented via a binder material. In some examples, the binder material is supplied from at least one of the ink particles, the carrier fluid, and the substrate. In some such examples, the substrate may comprise an electrically charged, semi-liquid image-receiving holder layer, as further described below. In some examples, the binder material may comprise a binder material which is active (to implement the distance-dependent molecular attraction) relative to other molecules, compositions, etc. prior to and/or without heating or curing.

In some examples, the image formation device may sometimes be referred to as a printer, printing device, or digital press.

In some examples, the fluid ejection device may comprise a drop-on-demand fluid ejection device to eject the droplets of ink particles (within the carrier fluid) onto the media. In some examples, the fluid ejection device comprises an inkjet printhead. In some examples, the inkjet printhead comprises a piezoelectric inkjet printhead. In some examples, the inkjet may comprise a thermal inkjet printhead. In some examples, the droplets may sometimes be referred to as being jetted onto the media. With this in mind, image formation according to at least some examples of the present disclosure may sometimes be referred to as “jet-on-blanket”, “jet-on-media” or “jet-on-substrate.”

In some examples, by providing for distance-dependent molecular fixation in addition to electrostatic fixation when relatively high conductivity inks are involved, the targeted position of the ink particles (to form an image) can be maintained even after the strength of the electrostatic fixation significantly decreases and before completion of various aspects of forming an image via an image formation device. Such distance-dependent molecular fixation for at least some high conductivity inks may prevent or minimize dot smearing, unintended dot expansion, unintentional loss of ink particles during excess liquid removal, etc. In addition, such example distance-dependent, molecular fixation may produce the same or similar results for some inks which may exhibit micelle behavior or may be exposed to other conductive particles within a carrier fluid, and therefore also might otherwise cause faster discharge, and decrease of the electrostatic forces.

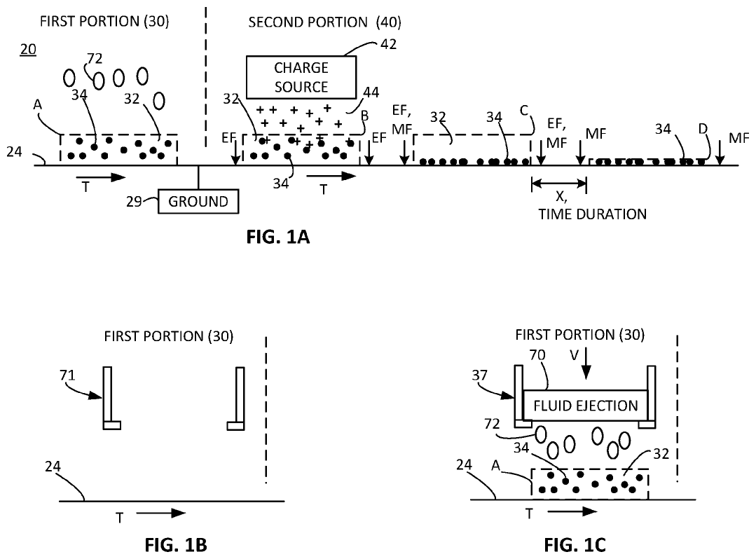

These examples, and additional examples, are further described below in association with at least FIGS. 1A-12.

FIG. 1A is a diagram including a side view schematically representing an example image formation device 20. It will be further understood that FIG. 1A also may be viewed as schematically representing at least some aspects of an example method of image formation.

As shown in FIG. 1A, in some examples an image formation device 20 comprises a first portion 30 and a second portion 40. The first portion 30 of image formation device 20 is located along and/or forms a portion of the travel path T of a movable substrate 24, and is to receive droplets 72 of ink particles 34 within a dielectric carrier fluid 32 on the substrate 24. The depiction within the dashed lines A in FIG. 1A represents ink particles 34 and carrier fluid 32 after being received on substrate 24 to form at least a portion of an image on the substrate 24. In some examples, the droplets 72 from which ink particles 34 are formed may comprise pigments, dispersants, the carrier fluid 32, and may comprise additives such as bonding polymers.

The substrate 24 may be in electrical connection with a ground element 29, and may comprise one of a variety of different types of substrates. In some examples, the substrate 24 may comprise a transfer member, such as a blanket of the type used in liquid electrophotographic (LEP) printing or other printing or such as a belt or web. In some examples, the substrate 24 may additionally comprise a primer layer or comprise an electrically charged, semi-liquid image-receiving holder layer supported by and carried by such a transfer member. In some examples, the substrate 24 may comprise an image formation medium supported and carried by a transfer member. Further details regarding at least some of these examples of substrate 24 are provided below in the context of various specific example implementations.

In some examples the substrate 24 may comprise an image formation medium, including but not limited to a plastic media. In some examples, as an image formation medium, the substrate 24 may comprise polyethylene (PET) material, which may comprise a thickness on the order of about 10 microns. In some examples, as an image formation medium, the substrate 24 may comprise a biaxially oriented polypropylene (BOPP) material. In some examples, as an image formation medium, the substrate 24 may comprise a biaxially oriented polyethylene terephthalate (BOPET) polyester film, which may be sold under trade name Mylar in some instances. In some examples, as an image formation medium, the substrate 24 or portions of substrate 24 may comprise a metallized foil or foil material, among other types of materials.

In some such examples, such print media may be supported and carried by a belt or other transfer member while in some examples, print media may be supplied by a media roll in a roll-to-roll arrangement such that a supporting belt may be omitted. In some such latter examples, the substrate 24 may sometimes be referred to as a media web.

In some examples, the substrate 24 may comprise other types of materials which provide at least some of the features and attributes as described throughout the examples of the present disclosure.

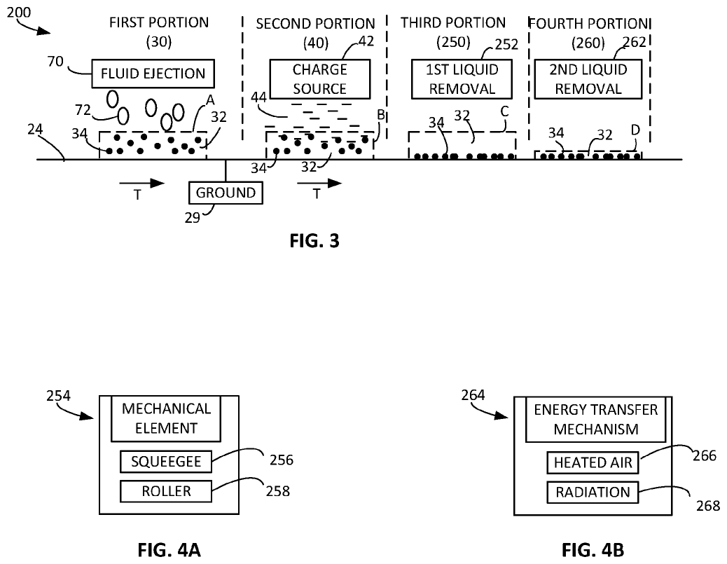

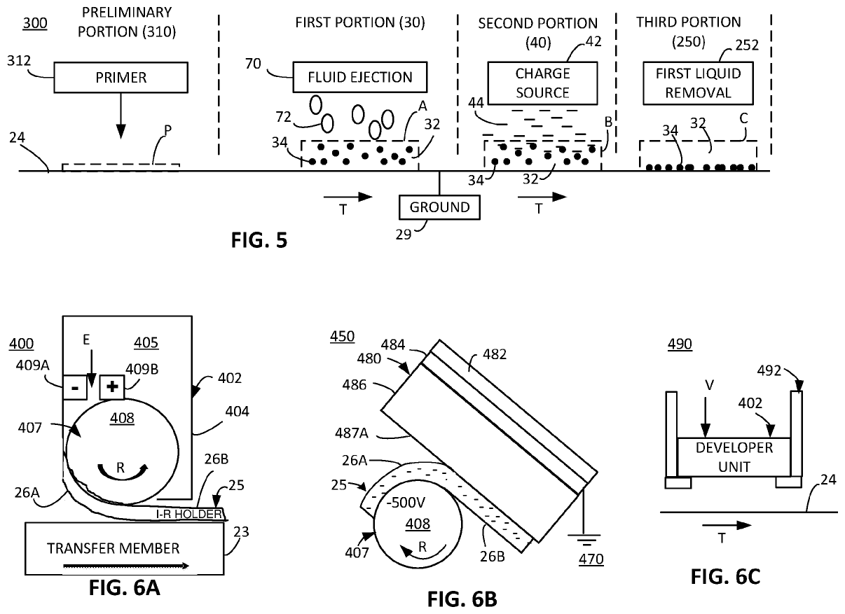

In some examples, the first portion 30 of image formation device 20 comprises a fluid ejection device to eject the droplets of ink particles 34 within the carrier fluid 32. At least FIGS. 3 and 5 provide an illustration of one such example fluid ejection device 70, which is positionable at a location spaced apart and above the substrate 24. In some examples, the fluid ejection device 70 comprises a drop-on-demand fluid ejection device. In some examples, the drop-on-demand fluid ejection device comprises an inkjet printhead. In some examples, the inkjet printhead comprises a piezoelectric inkjet printhead. In some examples, the fluid ejection device 70 may comprise other types of inkjet printheads.

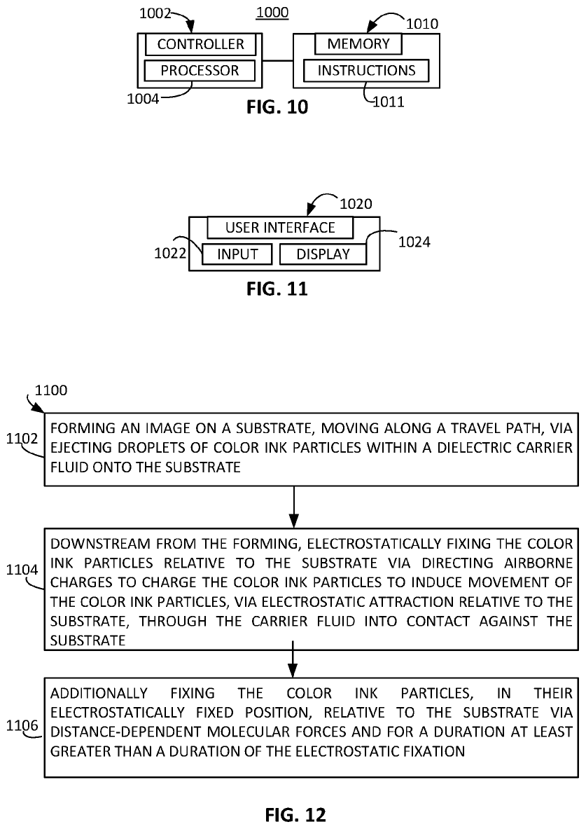

In some examples, as further described later in association with at least FIG. 10, among directing other and/or additional operations, a control portion 1000 is to instruct, or to cause, the fluid ejection device 70 to deliver the droplets 72 of ink particles 34 within the dielectric carrier fluid 32 onto the substrate 24, such as within the first portion along the travel path T of the substrate 24.

As further shown in FIG. 1B, in some examples the first portion 30 of image formation device 20 may comprise a receiving portion 71 to removably receive the fluid ejection device 70, such as in some examples in which the fluid ejection device 70 is removably insertable into the receiving portion 71. The receiving portion 71 is sized, shaped, and positioned relative to substrate 24, as well as relative to other components of image formation device 20, such that upon removable insertion relative to receiving portion 71 (as represented by arrow V in FIG. 1C), the fluid ejection device 70 is positioned to deliver (e.g. eject) the droplets 72 of ink particles 34 and dielectric carrier fluid 32 onto substrate 24, as shown in FIG. 1C. In some such examples, the fluid ejection device 70 may comprise a consumable which is periodically replaceable due to wear, exhaustion of an ink supply, etc. In some such examples, the fluid ejection device 70 may be sold, supplied, shipped, etc. separately from the rest of image formation device 20 and then installed into the image formation device 20 upon preparation for use of image formation device 20 at a particular location.

In some examples, as part of ejecting droplets (e.g. 72 in FIGS. 1A, 1C), the fluid ejection device 70 is to deposit the dielectric carrier fluid 32 on the substrate 24 as a non-aqueous liquid. In some examples, the non-aqueous liquid comprises an isoparrafinic fluid, which may be sold under the trade name ISOPAR™ by ExxonMobil™. In some such examples, the non-aqueous dielectric liquid may comprise other oil-based liquids suitable for use as a dielectric carrier fluid.

As further shown in FIG. 1A, in some examples, the second portion 40 of image formation device 20 is located downstream along the travel path T of substrate 24 from the first portion 30 and includes a charge source 42 to emit airborne charges 44 to charge the ink particles 34, as represented via the depiction in dashed lines B in FIG. 1A.

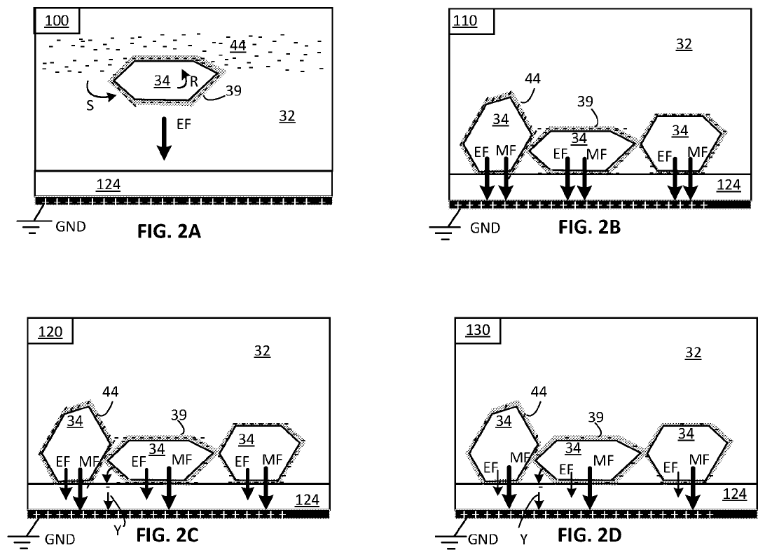

Once charged, the ink particles 34 move, via electrostatic attraction relative to the grounded substrate 24, through the carrier fluid 32 toward the substrate 24 to become electrostatically fixed on or relative to the substrate 24. The end result of their migration or movement is represented via the depiction in dashed lines C in FIG. 1A. Further details are described more fully later in association with at least FIGS. 2A-2D regarding the adherence of charges 44 to ink particles 34 in a suspended state within carrier fluid 32, movement of the charged ink particles 34, their electrostatic fixation relative to substrate 24, and/or their distance-dependent molecular fixation relative to substrate 24.

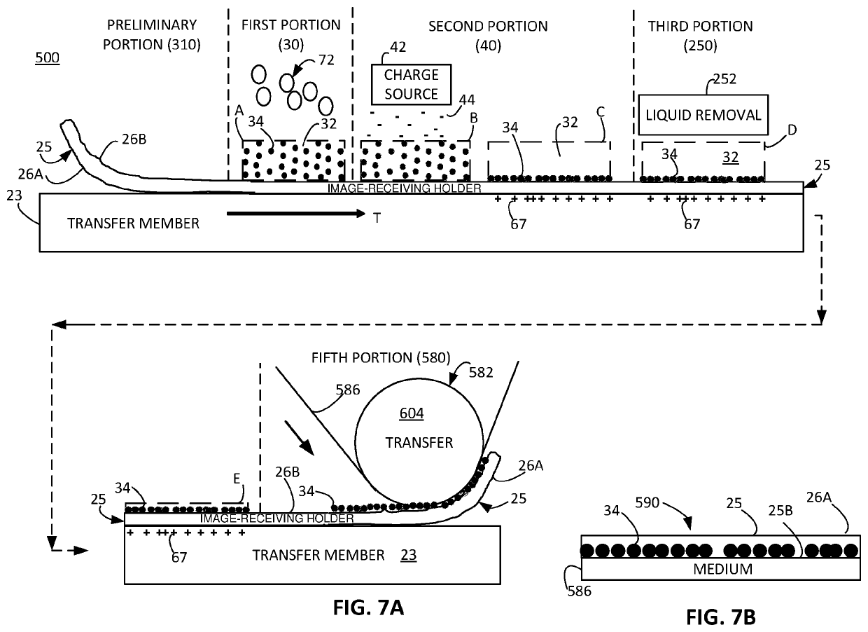

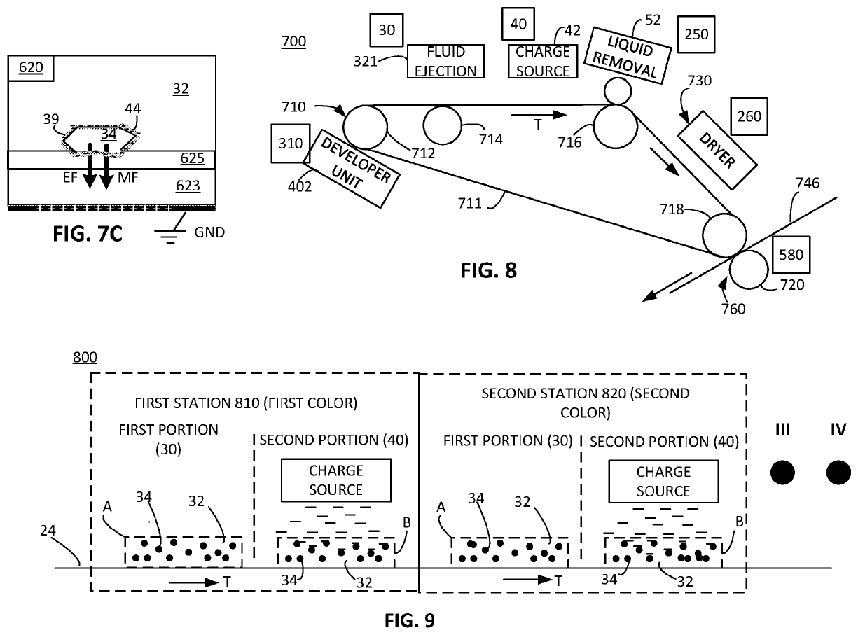

With further reference to FIG. 1A, in some examples the charge source 42 in the second portion 40 may comprise a corona, plasma element (e.g. cold plasma element), or other charge generating element to generate a flow or flux of charges 44. The generated charges may be negative or positive as desired. In some examples, the charge source 42 may comprise an ion head to produce a flow of ions as the charges 44. It will be understood that the term “charges” and the term “ions” may be used interchangeably to the extent that the respective “charges” or “ions” 44 embody a negative charge or positive charge (as determined by source 42) which can become attached to the ink particles 34 to cause all of the charged ink particles to have a particular polarity, which will be attracted to ground or an electrically conductive element of opposite polarity. In some such examples, all or substantially all of the charged ink particles 34 will have a negative charge or alternatively all or substantially all of the charged ink particles 34 will have a positive charge. While the charges 44 shown in FIGS. 1A-12 are depicted as having a particular polarity (positive or negative), it will be understood that the polarity of charges 44 may be selected and implemented in view of the polarity of other elements of an example image formation device (or associated with an example image formation device), such as a polarity of elements (e.g. charge directors, binder particles) within the electrically charged, image-receiving holder layer (e.g. 25 in FIGS. 6A-7C). It will be understood that other elements such as at least a portion of the substrate 24 and/or other elements (e.g. transfer member 23, 480 in FIGS. 6A-7C) in contact with (or otherwise coupled to) substrate 24 may exhibit, may develop, or be caused to exhibit charges having a polarity opposite from the polarity of the charges 44 (and therefore opposite from the polarity of the charged ink particles 34). Via such example arrangements of opposite polarity charges, the electrostatic attraction forces may be at least partially implemented. In some examples, the charges 44 may affect the charge level and/or the polarity of image-receiving holder layer 25 to keep the electrostatic attraction forces of particles 34 at least partially implemented.

Via at least some of the above-described example arrangements, the charged ink particles 34 become electrostatically fixed (as represented by arrows EF) on the substrate 24 in a location on the substrate 24 generally corresponding to the location (in an x-y orientation) at which they were initially received onto the substrate 24 in the first portion 30 of the image formation device 20. Via such electrostatic fixation (e.g. pinning), the ink particles 34 will retain their position on substrate 24 even when other ink particles (e.g. different colors) are added later, excess liquid is mechanically removed, physically removed, etc. It will be understood that while the ink particles may retain their position on substrate 24, some amount of expansion of a dot (formed of ink particles) may occur after the ink particles 34 (within carrier fluid 32) are jetted onto substrate 24 and before they are electrostatically pinned. In some examples, the charge source 42 is spaced apart by a predetermined distance (e.g. downstream) from the location at which the droplets are received (or ejected) with the distance selected in order to delay the electrostatic fixation (per operation of charge source 42), which can in turn cause an increase in dot size on substrate 24, which may in turn may lower ink consumption.

In some examples, the ground element 29 may comprise an electrically conductive element in contact with a portion of the substrate 24. In some examples, the electrically conductive element may comprise a roller or plate in rolling or slidable contact, respectively, with a portion of the media. In some examples, the ground element 29 is in contact with an edge or end of the media. In some examples, the electrically conductive element may take other forms, such as a brush or other structures. Accordingly, it will be understood that the ground element 29 is not limited to the particular location shown in FIG. 1A.

As further described below and as represented via arrows MF in FIG. 1A, in some examples in addition to the electrostatic fixation in particular location (according to the pattern of an image), the ink particles become molecularly fixed by distance-dependent, molecular forces (MF) in their electrostatically fixed locations for a duration at least greater than a duration of the electrostatic fixation. It will be understood that the distance-dependent, molecular fixation may be initiated and continue in generally the same time frame as at least initiation of the electrostatic fixation. In some examples, the distance-dependent, molecular fixation may be initiated at a point in time after the initial electrostatic fixation of the ink particles against the substrate, but while the electrostatic fixation remains sufficiently strong to hold the ink particles against the substrate in their respective positions (i.e. in their electrostatically pinned positions) at least until the distance-dependent, molecular fixation becomes sufficiently strong to hold the ink particles in their electrostatically fixed positions. Accordingly, FIG. 1A depicts both arrows EF (representing electrostatic forces or fixation) and arrows MF (representing distance-dependent, molecular forces or fixation) in association with dashed box C. As noted above, the ink particles 34 become molecularly fixed (MF) in their electrostatically fixed locations for a duration at least greater than a duration of the electrostatic fixation.

In some examples, an expected duration of electrostatic fixation for low conductivity inks (e.g. less than 100, 200, or 300 pS/cm) is on the order of hundreds of milliseconds. Meanwhile, the expected duration of electrostatic fixation for relatively high conductivity inks (e.g. at least 500 pS/cm) is on the order of tens of milliseconds whereas pinning of ink particles 34 for a desired duration (sufficient to perform high quality imaging) may be on the order of hundreds of milliseconds. The duration of molecular fixation with high conductivity inks is substantially greater than (e.g. 25% more, 50% more, 75% more, 2×, 3×, etc.) the duration of electrostatic fixation for high conductivity inks. In some examples, this “substantially greater” difference in duration may be at least one order of magnitude and in some examples, the difference in duration may be at least two orders of magnitude. Some such examples of the “substantially greater” difference in duration also may be applicable to low conductivity inks, such as inks having a conductivity on the order of 350 pS/cm or less and the examples further described below.

Based on a speed of travel of substrate 24, the duration of holding by molecular forces (MF) may correspond to at least a distance (X in FIG. 1A) of travel along travel path T. In some examples, the duration of holding by the molecular forces (MF) extends beyond removal of excess liquid, transfer of a formed image from the substrate 24 to an image formation medium, etc.

In the case of at least some low conductivity inks, the electrostatic force (EF) may be sufficient to maintain fixation of ink particles 34 in targeted location through completion of image formation, including excess liquid removal, drying, transfer, etc. without additional help from distance-dependent, molecular attractive forces (MF) even though the molecular forces may nonetheless be present. In some examples, a low conductivity ink may comprise an ink having an electrical conductivity of 100 pS/cm or less, of about 150 pS/cm or less, of about 200 pS/cm or less, of about 250 pS/cm or less, of about 300 pS/cm or less, of about 350 pS/cm or less.

However, in the case of high conductivity inks, such as those inks with conductivity of at least about 500 pS/cm and/or those inks which may exhibit conductive micelle behavior, the electrostatic forces (EF) may dissipate (in some instances) substantially faster than for low conductivity inks. In such cases, the molecular forces act to preserve the targeted location of the ink particles 34 (in the form of an image) that was initially secured and maintained via electrostatic forces (EF). In some examples, conductive micelle behavior may comprise micelles or other particles which are conductive and which form part of, or originate from, the overall ink formulation deposited as droplets 72. These conductive micelles or particles may increase the conductivity of the individual ink particles 34, thereby contributing to faster discharge once at substrate 24.

In some examples, the high conductivity ink may comprise a conductivity of at least about 550 pS/cm, of at least about 600 pS/cm, of at least about 650 pS/cm, of at least about 700 pS/cm, of at least about 750 pS/cm, of at least about 800 pS/cm, of at least about 850 pS/cm, of at least about 900 pS/cm, of at least about 950 pS/cm, or at least about 1000 pS/cm. In some examples, the high conductivity ink may comprise a conductivity of at least one order of magnitude greater than a conductivity of 100 pS/cm.

FIG. 2A is a diagram 100 including a side view schematically representing at least some aspects of example image formation per at least example image formation device 20 (FIG. 1A). The depiction in FIG. 2A corresponds to a point in time at which the droplets 72 have already been deposited on substrate 24 such that ink particles 34 are dispersed and suspended in carrier fluid 32 in a layer sitting on top of substrate 24. In this arrangement, the layer of carrier fluid 32 may have a thickness on the order of 10 microns in some examples. As further shown in the diagram of FIG. 2A, as airborne-charges 44 are directed from charge source 42 (FIG. 1A) onto ink particles 34, the charges 44 become adhered to an outer surface of the ink particles 34 while in their suspended position within carrier fluid 32. As represented via arrow S, the charges 44 will descend in a manner to adhere to the entire outer surface of the ink particles 34 either via lateral surface conductivity of the ink particle (e.g. pigment), lateral movement of some charges 44, and/or because of rotation of the ink particles 34, as represented via arrow R. In some examples, the charges 44 adhere to less than the entire outer surface of the ink particles 34, i.e. the charges 44 adhere to just some of the entire outer surface of at least some of the ink particle(s) 34.

Upon adherence of charges 44 to ink particle(s) 34, the electrostatic force (EF) which attracts charges 44 to a ground-connected substrate 24 pulls the ink particles 34 toward substrate 24 until the ink particle(s) 34 are in contact against substrate 24 as shown in FIG. 2B. The ink particles 34 remain in contact against (i.e. pinned) substrate 24 due to the strength of the electrostatic forces (EF), which are on the order of millions times greater than the force of gravity. As previously noted, the location at which the ink particles 34 become pinned corresponds to their targeted location as part of a pattern of deposited ink particles 34 to form an image on substrate 24. Accordingly, the ink particles 34 will remain in their electrostatically fixed (e.g. pinned) location as long as the electrostatic forces remain sufficiently strong.

As also shown in FIG. 2A, in some examples the outer surface of the ink particle 34 may be at least partially coated in a binder material 39 (represented by shaded outline of ink particle 34), which may comprise a resin, binding polymer, etc. As represented by arrows MF in FIG. 2B, a distance-dependent, molecular attractive force (arrows MF) of the binder material 39 on the ink particle 34 relative to materials in or on the substrate 24 also maintains the ink particle 34 in its intended location. In this way, the distance-dependent molecular forces (MF) supplement the electrostatic forces (EF). In some examples, the distance-dependent, molecular forces (MF) may have an attractive strength on the order of millions times the force of gravity. In many cases, this strong attractive electrostatic (EF) force enables a strong molecular force (MF) by bringing the ink particle 34 into a proximity on the order of one nanometer or less to the substrate 24 where the distance-dependent, molecular attractive forces (MF) will occur.

In some examples, the distance-dependent proximity threshold is about 1.5 nanometers or less. In some examples, the distance-dependent proximity threshold is about 0.9 nanometers or less. In some examples, the distance-dependent proximity threshold is about 0.8 nanometers or less. In some examples, the distance-dependent proximity threshold is about 0.7 nanometers or less while in some examples, the distance-dependent proximity threshold is about 0.6 nanometers of less. In some examples, the distance-dependent proximity threshold is about 0.5 nanometers or less.

In some examples, the image formation device 20 may enhance the attractive strength of the electrostatic forces (EF) via controlling an intensity of the charges 44 delivered by charge source 42. In some examples, such control of charge source 42 emitting a particular intensity of charges 44 is at least partially implemented via control portion 1000 (FIG. 10). In some examples, in order to create electronic forces (EF) strong enough to facilitate the occurrence of the distance-dependent, molecular attractive forces (MF) at the above-described example distances, the charge source 42 may emit charges at a first predetermined intensity of at least about 50 nC/cm². In some examples, the first predetermined intensity may be at least about 45 nC/cm², at least about 55 nC/cm², at least about 60 nC/cm², at least about 65 nC/cm², at least about 70 nC/cm², and at least about 80 nC/cm².

In some examples, in combination with the first predetermined intensity of charges emitted by charge source 42, the image formation device 20 may enhance the attractive strength of the electrostatic forces (EF) (to facilitate the distance-dependent molecular fixation) via providing a binder material 39 which is active without heating or curing and/or which is active prior to heating and/or curing stations of the image formation device 20. In some such examples, the binder material 39 may comprise about 15 to about 35 percent weight of a resin, such as but not limited to, ethylene acid copolymers and ethylene vinyl acetate copolymers.

FIGS. 2A-2C depict the ink particles 34 as being encapsulated in or otherwise coated in a binder material 39. However, in some examples, the carrier fluid 32 may comprise at least some of the binder material 39. Whether supplied via ink particles 34, the carrier fluid 32, and/or the substrate 24, it will be understood that a total volume of binder material 39 is supplied which will be sufficient to implement the electrostatic forces (EF) and/or the distance-dependent, molecular attractive fixation (MF) or at least sufficient to assist other binder materials to produce the requisite distance-dependent, molecular attractive fixation (MF).

In some examples, the ink particles 34 are not coated in a binder material 39 and instead all of the binder material 39 may supplied by an electrically charged, semi-liquid image-receiving holder layer 25 acting as the substrate 24, as will be further described later in association with at least some examples described in relation to at least FIGS. 6A-7C. In some such examples, providing such an image-receiving holder layer 25 may enhance the attractive strength of the electrostatic forces (EF) to facilitate the distance-dependent molecular forces (MF) acting on the ink particles 34 to fix them relative to the image-receiving holder layer 25. As more fully described later, in some such examples the intensity of the attractive strength of the electrostatic forces (EF) (to implement the distance-dependent molecular forces) may be at least partially implemented via a transfer member 23 on which the image-receiving holder layer 25 is carried, wherein an outer layer of the transfer member comprises a resistivity of about 10⁴ Ohm-cm to about 10⁷ Ohm-cm.

As previously described, in some instances certain inks having a high conductivity (e.g. at least about 500 pS/cm, at least about 550 pS/cm, etc.) or having significant micelle behavior, may exhibit a relatively fast discharge of the charges 44 to ground (GND), as represented by arrows Y in FIGS. 2C-2D. This fast discharge may, in turn, result in a significant decrease in the electrostatic holding forces (EF) as represented via the shorter, and smaller EF arrows in FIG. 2C. The electrostatic forces EF may continue to decrease over time due to such discharge, as further represented by even shorter, smaller EF arrow in FIG. 2D. However, in such examples, despite the diminished electrostatic force (EF), the distance-dependent, molecular attractive forces (MF) remain sufficiently strong to maintain the ink particles 34 in their targeted location on substrate 24.

Whether held by electrostatic forces (EF) and/or by distance-dependent, molecular attractive forces (MF), pinning the ink particles 34 relative to the substrate 24 via the example image formation devices may prevent or minimize image smearing, unintended dot expansion, unintentional removal of some ink particles via cold liquid removal (e.g. at least liquid removal portion 252).

In one aspect, once the ink particles 34 become pinned against substrate 24 as shown in at least FIGS. 2B-2D, the carrier fluid 32 exhibits supernatant-like behavior by its suspension above the layer of ink particles 34 pinned against the substrate 24. Accordingly, this arrangement facilitates mechanical removal of such liquid without disturbing the pinned ink particles 34.

FIG. 3 is a diagram including a side view schematically representing an example image formation device 200. In some examples, device 200 comprises at least some of substantially the same features and attributes as device 20 previously described in association with FIGS. 1A-2C. It will be further understood that FIG. 3 also may be viewed as schematically representing at least some aspects of an example method of image formation.

As shown in FIG. 3, the image formation device 200 comprises first portion 30 and second portion 40 having substantially the same features and attributes as in device 20 in FIG. 1A, along with additional features as further described below. In some examples, fluid ejection device 70 in the first portion 30 may comprise a permanent component of image formation device 300, which is sold, shipped, and/or supplied, etc. as part of image formation device 300. It will be understood that such “permanent” components may be removed for repair, upgrade, etc. as appropriate. However, in some examples, first portion 30 may comprise a receiving portion 71 to removably receive fluid ejection device 70, as previously described in association with FIGS. 1B-1C, such as in instances when fluid ejection device 70 may comprise a consumable, be separately sold, etc.

As shown in FIG. 3, in some examples image formation device 200 comprises a third portion 250, including a first liquid removal portion or element 252, downstream along the travel path T from the charge source 42 (in second portion 40), to remove at least a portion of the carrier fluid 32 from the substrate 24. The first liquid removal portion 252 is to at least mechanically remove excess volumes of liquid, including carrier fluid 32 which has accumulated on the substrate 24 as a result of receiving droplets 72 in the second portion 50. In some examples, the liquid (e.g. oil, other, etc.) is in a supernatant-like state, i.e. suspended above pinned ink particles 34. With this in mind, after implementation of electrostatic fixation and/or distance-dependent, molecular fixation of the charged ink particles relative to the substrate 24 (in the form of at least a portion of an image) as shown via the dashed box C in FIG. 1A, the excess liquid 32 no longer useful for the current instance of image formation and therefore is removed as reflected by dashed box D in FIG. 1A and FIG. 3. In some examples, the collected excess liquid may be recovered and re-used in future depositions of droplets in the first portion 30 in subsequent instances of image formation via the image formation device 20 or for other purposes.

In some examples, the first liquid removal portion 252 is to remove the carrier fluid 32 without heating the fluid 32 at all or without heating the carrier fluid 32 above a predetermined threshold. In some instances, such liquid removal may sometimes be referred to as cold liquid removal to refer to the liquid being removed at relatively cool temperatures, at least as compared to high heat drying techniques. Accordingly, in some such examples, a mechanical element (e.g. squeegee roller) of the first liquid removal portion 252 may slightly heat the carrier fluid 32 and/or other liquid without using heat as a primary mechanism to remove the carrier fluid 32 from the ink particles 34 on substrate 24. In some instances in which the carrier fluid 32 comprises an oil, the liquid removal may sometimes be referred to as cold oil removal.

As further shown in FIG. 4A, the first liquid removal portion 252 may comprise a mechanical element 254 to remove the carrier fluid 32 (and any other liquid) from the surface of substrate 24. In some examples, the mechanical element 254 may comprise a squeegee 256 or roller 258, and/or other element. In some examples, the electrostatically fixed (e.g. pinned) ink particles 34 remain fixed in their respective locations on substrate 24 during this mechanical removal of liquid at least because the electrostatic fixation forces and/or distance-dependent, molecular fixation forces are greater than the shear forces exhibited via the tool(s) used to mechanically remove the carrier fluid 32. In the third portion 250 of image formation device 200 (FIG. 3), in some examples, at least 80 percent of the jetted carrier fluid 32 on substrate 24 is removed. In some examples, at least 90 percent of the jetted carrier fluid 32 is removed. In some examples, at least 95 percent of the jetted carrier fluid 32 is removed. However, in some examples, first liquid removal portion 252 may remove at least 50 percent of total liquid, which includes the carrier fluid 32, from substrate 24.

In some such examples, performing such cold liquid removal may substantially decrease the amount of energy used to remove deposited liquid (e.g. from the top of substrate 24) as compared to using a heated air dryer primarily or solely to remove the liquid. In some examples, in this context the term “substantially decrease” may correspond to at least 10×, at least 20×, or at least 30×. In addition, using cold liquid removal via example image formation devices (e.g. 20, 200, etc.) may significantly decrease the space or volume occupied by such an example image formation device, thereby reducing its cost and/or cost of space in which the image formation device may reside.

As further shown in FIG. 3, in some examples the image formation device 200 may further comprise a second liquid removal portion 262 (in fourth portion 260) downstream from the first liquid removal portion 252. The second liquid removal portion 262 acts to remove any liquid not removed via first liquid removal portion 252 (in third portion 250) and thereby result in dried ink particles 34 on the substrate 24, as represented via the depictions in dashed lines D in FIG. 3.

As later shown in FIG. 4B, in some examples the second liquid removal portion 262 may comprise an energy transfer mechanism or structure by which energy is transferred to the liquid 32, ink particles 34, and substrate 24 in order to dry the ink particles 34 and/or substrate 24. In some examples, the energy transfer mechanism 264 may comprise a heated air element 266 to direct heated air onto at least the carrier fluid 32 and substrate 24. In some examples, the heated air is controlled to maintain the ink particles 34, substrate 24, etc. at a temperature below 60 degrees C., which may prevent deformation of substrate 24 such as cockling, etc.

In some examples, the energy transfer mechanism 264 may comprise a radiation element 268 to direct at least one of infrared (IR) radiation and ultraviolet (UV) radiation onto the liquid 32 and substrate 24 to eliminate liquid remaining after operation of the first liquid removal portion 252.

In some examples, the second liquid removal portion 262 may be implemented as and/or sometimes be referred to as a dryer, such as dryer 730 in FIG. 8.

In some examples, the energy transfer mechanism 264 also may assist in curing various polymers and/or other materials which form part of the formed image on substrate 24.

While at least some examples of image formation device 20 may comprise an energy transfer mechanism 264 to remove remaining amounts of liquid after liquid removal portion 252, it will be understood that the transmitted energy also may facilitate solidifying the binder (e.g. from image-receiving holder layer 25 or other source) with ink particles 34 (from droplets 72) to complete formation and solidification of the image on the image-receiving holder layer 25.

While not shown in FIG. 3 for illustrative simplicity, it will be understood that in some examples image formation device 200 may further comprise a finish treatment element downstream from the second liquid removal portion 262 (in fourth portion 260) to add a finish layer on top of the ink particles 34 electrostatically fixed and/or molecularly fixed on the substrate 24. The finish layer may enhance adhesion of the ink particles 34 to the substrate 24, protect the image formed by the ink particles 34, etc. The material applied as a finish layer may be ultraviolet curable, a solvent, water-based, etc. In some examples, the material applied as a finish layer may be a sealant, adhesion promoter, varnish, and the like, as well as various combinations of such finishing materials.

With reference to at least FIG. 3 and the later-described FIGS. 5, 7A, 8-9, it will be understood that in some examples the labeling of the various portions as preliminary, first, second, third portions etc. (e.g. 310, 30, 40, 250, 260 etc.) does not necessarily reflect an absolute ordering or position of the respective portions along the travel path T. Moreover, such labeling of different portions also does not necessarily represent the existence of structural barriers or separation elements between adjacent portions of the image formation device 20, 200, 300, etc. Furthermore, in some examples, the components of an example image formation device (e.g. 20, 200, 300, etc.) may be organized into a fewer or greater number of portions than represented in FIGS. 1A, 3, 5, 7A, etc.

FIG. 5 is a diagram including a side view schematically representing an example image formation device 300. In some examples, the example image formation device 300 comprises at least some of substantially the same features as the example image formation devices 20, 200 (FIGS. 1A-4B), including the previously-described, electrostatic fixation and/or molecular fixation of ink particles 34 relative to substrate 24. It will be further understood that FIG. 5 also may be viewed as schematically representing at least some aspects of an example method of image formation.

However, in the example image formation device 300 in FIG. 5, a preliminary portion 310 precedes the first portion 30. The preliminary portion 310 is located upstream from (e.g. precedes) the first portion 30 and comprises a primer element 312 to deposit a primer layer on substrate 24, as represented via dashed box P. In some examples, the primer layer P comprises material(s) which prepare the surface of substrate 24 to receive droplets of ink particles 34 within the carrier fluid 32 in the first portion 30. In some examples, the primer material (P) may facilitate electrostatic fixation (EF) and/or molecular fixation (MF) of the ink particles 34 relative to the substrate 24. Some example primer materials may comprise a resin particles, dissolved resin, binding polymers, and/or adhesion promoting materials.

In some examples, a preliminary portion 310 of an example image formation device (e.g. 300 in FIG. 5) may comprise a developer unit 402, as shown in FIGS. 6A-6C, to develop and apply an image-receiving holder layer 25 onto a transfer member 23. In such examples, the image-receiving holder layer 25 (supported by transfer member 23) may be considered one example implementation of substrate 24.

FIG. 6A provides a diagram 400 schematically representing one example developer unit 402. In some examples, the developer unit 402 may comprise at least some of substantially the same features and attributes as a developer unit as would be implemented in a liquid electrophotographic (LEP) printer, such as but not limited to, an Indigo brand liquid electrophotographic printer sold by HP, Inc. In some examples, the developer unit may comprise a binary developer (BID) unit. In some examples, the developer unit 402 may comprise at least some of the features of a binary developer (BID) unit as described in Nelson et al. US20180231922.

As shown in FIG. 6A, in some examples, the developer unit 402 comprises a container 404 for holding various materials 405 (e.g. liquids and/or solids) from which a formulation is developed into semi-liquid, image-receiving holder layer 25. The materials 405 may comprise binding materials, such as resin particles, dissolved resin, binding polymers (dissolved or as resins), or adhesion promoting materials, as well as materials such as (but not limited to) dispersants, charge directors, mineral oils, foam depressing agents, UV absorbers, cross linking initiators and components, heavy oils, blanket release promoters, and/or scratch resistance additives. In one aspect, the materials 405 in any given formulation of the image-receiving holder layer 25 are combined in a manner such that materials 405 will be flowable in order to enable formation of the image-receiving holder as a layer 25 on transfer member 23. In some examples, a mineral oil portion of the materials 405 may be more than 50 percent by weight of all the materials 405. In some such examples, the mineral oil portion may comprise an isoparrafinic fluid. In some examples, the binding materials may facilitate the electrostatic force fixation and/or the distance-dependent, molecular attractive forces and molecular fixation (MF) of the ink particles 34 relative to the image-receiving holder layer 25, as previously described in association with at least FIGS. 1A, 2A-2D.

In some examples, the container 404 may comprise individual reservoirs, valves, inlets, outlets, etc. for separately holding at least some of the materials 405 and then mixing them into a desired paste material to form an image-receiving holder as layer 25. In some examples, the developed paste may comprise at least about 20 percent to about 30 percent solids, which may comprise resin or binder components and may comprise at least charge director additives along with the binder materials. In some examples, the solids and charge director additives are provided within a dielectric carrier fluid, such a non-aqueous fluid, such as but not limited to the above-described isoparrafinic fluid. In some examples, solid particles within the paste have a largest dimension (e.g. length, diameter) on the order of about 1 or about 2 microns.

In some examples, the charge director additives in the materials 405 may comprise a negative charge director (CD) or a synthetic charge director (SCD). In one example, the charge director can be an NCD comprising a mixture of charging components. In another example, the NCD can comprise at least one of the following: zwitterionic material, such as soya lecithin; basic barium petronate (BBP); calcium petronate; isopropyl amine dodecylebezene sulfonic acid; etc. In one specific non-limiting example, the NCD can comprise soya lecithin at 6.6% w/w, BBP at 9.8% w/w, isopropyl amine dodecylebezene sulfonic acid at 3.6% w/w and about 80% w/w isoparaffin (Isopar®-L from Exxon). Additionally, the NCD can comprise any ionic surfactant and/or electron carrier dissolved material. In one example, the charge director can be a synthetic charge director. The charge director can also include aluminum tri-stearate, barium stearate, chromium stearate, magnesium octoate, iron naphthenate, zinc napththenate, and mixtures thereof.

As further shown in FIG. 6A, the developer unit 402 comprises a roller assembly 407 disposed at least partially within container 404 and selectively exposed to the formulated paste used to form image-receiving holder layer 25. In some examples, the transfer member 23 may be implemented as transfer member 480 as shown in FIG. 6B. The roller assembly 407 comprises a developer drum 408 (or roller), which is driven to a negative voltage (e.g. −500 V) for electrostatically charging the paste and electrostatically delivering the charged paste as image-receiving holder layer 25 on the transfer member 23, 480, as shown in FIGS. 6A-6B. In one such example, the paste of materials 405 is negatively charged. In some examples, the charge director additives receive and hold the negative charge in a manner to thereby negatively charge at least the binder materials within the paste of materials 405 when an electrical field is applied to the paste of materials 405, such as via the development roller 408 at −500 Volts. Via such example arrangements, the image-receiving holder layer 25 may sometimes be referred to as an electrically charged, image-receiving holder layer.

In some examples, the developer drum or roller 408 may comprise a conductive polymer, such as but not limited to polyurethane or may comprise a metal material, such as but not limited to, Aluminum or stainless steel.

In some examples, the materials 405 may start out within the container 404 (among various reservoirs, supplies) with about 3 percent solids among various liquids, and via a combination of electrodes (e.g. at least 409A, 409B in FIG. 6A) “squeeze” the formulation into a paste of at least about 20 percent solids, as noted above. As shown in at least FIG. 6B, the paste of materials 405 is applied as a layer (onto transfer member 480) having a thickness of about 4 to about 8 microns, in at least some examples. It will be understood that the volume and/or thickness of the electrically charged, semi-liquid layer (forming image-receiving holder 25) that is transferred from the developer unit 402 to the transfer member 23 may be controlled based on a voltage (e.g. −500V) of the developer roller 408 and/or a charge level of the solid particles within the paste produced by the developer unit 402.

In some examples, as further described later in association with at least FIG. 10, among directing other and/or additional operations, a control portion 1000 is instruct, or to cause, the developer unit 402 to apply the electrically charged, semi-liquid image-receiving holder layer 25 onto transfer member 23, such as within the preliminary portion 310 along the travel path T.

Upon rotation of at least drum 408 of the roller assembly 407, and other manipulations associated with container 405, the drum 408 electrostatically attracts some of the charged developed material to form image-receiving holder layer 25, which is then deposited onto transfer member 23 as shown in FIGS. 6A-6B.

During such coating, the image-receiving holder layer 25 becomes electrostatically releasably fixed relative to the transfer member 23. In this arrangement, a first surface 26A (i.e. side) of the image-receiving holder layer 25 faces the transfer member 23 while an opposite second surface 26B of the image-receiving holder layer 25 faces away from transfer member 23.

In some examples the transfer member 23 may comprise a transfer member 480. In some such examples, the transfer member 480 comprises an outer layer 486, an electrically conductive layer 484, and a backing layer 482. In some examples, the transfer member 480 comprises at least some electrically conductive material (e.g. layer 484) which may facilitate attracting the negatively charged paste to complete formation of image-receiving holder layer 25 on a surface 487A of an outer layer 486, as shown in FIG. 6B.

In some such examples, the outer layer 486 may comprise a layer which is compliant at least with respect to a particular media onto which the formed image will be transferred. In some examples, the outer layer 486 may comprise a silicone rubber layer and is made of a flexible, resilient material. In some such examples, the electrical conductivity of outer layer 486 may be in the range of about 10⁴ Ohm-cm to about 10⁷ Ohm-cm, although in some examples, the electrical conductivity may extend outside this range. The electrical properties of layer 486 can be optimized with regards to voltage drop, charge conductivity across the layer, response time, and arcing risks.

In some examples, the electrically conductive layer 484 of transfer member 480 may comprise of a conductive rubber like silicone, a conductive plastic like polyvinyl chloride (PVC), or a polycarbonate which typically is doped with carbon pigments to become conductive. In some examples, the electrically conductive layer 484 may comprise other conductive inks, adhesives, or curable conductive paste could also be used as well as metalized layer. In some examples, the electrically conductive layer 484 may comprise a sheet resistance of less than 100 ohm/sq and be made from materials which are more conductive than 0.1 Ohm-cm.

As shown in FIG. 2B, in some examples the electrically conductive layer 284 is electrically connected to an electrical ground 270.

In some examples, the backing layer 482 may comprise a fabric, polyamide material, and the like in order to provide some stiffness to the transfer member 480, among other functions. In some examples, the outer layer 486 may comprise a thickness of about 100 microns while the electrically conductive layer 484 may comprise a thickness on the order of a few microns.

In some examples, the transfer member 480 may comprise a release layer of a few microns thickness on top of the outer layer 486 in order to facilitate selective release of image-receiving holder layer 25 from the transfer member 480 at a later point in time, such as at a transfer station to transfer image-receiving holder layer 25 (with ink particles 34 thereon) onto an image formation medium.

In some examples, the developer unit 402 may comprise a permanent component of an image formation device (e.g. 20, 200, 300, etc.) with the developer unit 402 being sold, shipped, and/or supplied, etc. as part of image formation device (e.g. 20, 200, 300, etc.). It will be understood that such “permanent” components may be removed for repair, upgrade, etc. as appropriate.

As shown in FIG. 6C, in some examples an image formation device (e.g. 20, 200, 300, etc.) may comprise a receiving portion 492 like receiving portion 71 in FIG. 1B, except to removably receive the developer unit 402 instead of receiving a fluid ejection device 70. Accordingly, in some examples the developer unit 402 is removably insertable into the receiving portion 492, as shown in at least FIG. 6C. In some such examples, the receiving portion 492 is sized, shaped, and positioned relative to transfer member (e.g. 23 in FIG. 6A, 480 in FIGS. 6B, 7A), as well as relative to other components of image formation device (e.g. 20, 200, 300, etc.), such that upon removable insertion into to receiving portion 492 (as represented by arrow V in FIG. 6C), the developer unit 402 is positioned to deliver the image-receiving holder layer 25 onto transfer member 23, 480 (FIGS. 6A-6B, 7A) or other substrate 24 (e.g. FIG. 1A).

In a manner consistent with the previously-described example image formation devices, in some examples the image formation device 300 is to cause electrostatic fixation and/or molecular fixation of ink particles 34 relative to the developed image-receiving holder layer 25, thereby ensuring that the ink particles 34 remain in their targeted locations to form a high quality image. Accordingly, while FIG. 5 omits depicting the electrostatic force (EF) and molecular force (MF) arrows previously shown in FIGS. 1A, 2B-2C, it will be understood that such forces are present in at least the second, third, etc. portions of the image formation device 500.

In some examples, the developer unit 402 may comprise a consumable which is periodically replaceable due to wear, exhaustion of a supply of materials, developer components, etc. In some such examples, the developer unit 402 may be sold, supplied, shipped, etc. separately from the rest of an image formation device (e.g. 20, 200, 300, 500 etc.) and then installed into the respective image formation device (e.g. 20, 200, 300, 500, etc.) upon preparation for use of the image formation device at a particular location. Accordingly, it will be apparent that in some examples the receiving portion 492 may comprise part of the preliminary portion 310 of image formation device 300 in FIG. 5 or image formation device 700 in FIG. 8, or a preliminary portion (when applicable) of another one of the example image formation devices described in the present disclosure.

When the developer unit 402 is present, in some examples its operation may comprise developing the image-receiving holder layer 25 without any color pigments in the image-receiving holder layer 25, such that the image-receiving holder layer 25 may sometimes be referred to as being colorless. In this arrangement, the image-receiving holder layer 25 corresponds to a liquid-based ink formulation which comprises at least some of substantially the same components as used in liquid electrophotographic (LEP) process, except for omitting the color pigments. In addition to being colorless in some examples, the material used to form the image-receiving holder layer also may be transparent and/or translucent upon application to an image formation medium or to a transfer member 23, 480 (FIGS. 6A-6B, 7A).

In some examples, the image-receiving holder layer 25 may comprise some color pigments so as to provide a tint. In some such examples, such color pigments may be transparent or translucent as well so as to not interfere with, or otherwise, affect the formation or appearance of an image via the ink particles 34 deposited via a fluid ejection device (e.g. 70).

In at least some examples in which the image-receiving holder layer 25 omits color pigments, the materials of the image-receiving holder layer 25 effectively do not comprise part of the image resulting from the deposited color ink particles which will be later transferred (with the image-receiving holder layer 25) onto an image formation medium. Accordingly, in some such examples the image-receiving holder layer 25 also may sometimes be referred to as a non-imaging, image-receiving holder layer 25.

In some such examples, the image-receiving holder layer 25 comprises all (e.g. 100 percent) of the binder used to form an image (including ink particles 34) on transfer member 23 (and later on an image formation medium). In some such examples, image-receiving holder layer 25 comprises at least substantially all (e.g. substantially the entire volume) of the binder used to form the image (including ink particles). In some such examples, in this context the term “at least substantially all” (or at least substantially the entire) comprises at least 95%. In some such examples “at least substantially all” (or at least substantially the entire) comprises at least 98%. In some examples in which the image-receiving holder layer 25 may comprise less than 100 percent of the binder used to form the image on the transfer member 23 (and later on an image formation medium), the remaining desired amount of binder may form part of droplets 72 delivered in the first portion 30 of an image formation device (e.g. 20, 200, 300, etc.). It will be understood that the term binder may encompass resin, binder materials, and/or polymers, and the like to complete image formation with the ink particles 34. In some examples, a mineral oil portion of the materials 405 (which includes the binder) may be more than 50 percent by weight of all the materials 405.

As further noted below, formulating the image-receiving holder layer 25 to comprise at least substantially all of the binder material(s) to be used to form an image on the transfer member 23, 480 (and later on an image formation medium) acts to free the first portion 30 (and fluid ejection device 70) so that, in at least some examples, the droplets (e.g. 72 in FIGS. 1A-1C, 3) may omit any binder material, and therefore be “binder-free.” Accordingly, in some examples, the droplets 72 may sometimes be referred to as being binder-free droplets.

In some examples, the droplets 72 omit charge director additives and therefore may sometimes be referred to as being charge-director-free. In some such examples, the image-receiving holder layer 25 may comprise some charge-director additives as further described with respect to developer unit 402 (FIGS. 6A-6B).

This example arrangement of supplying all or substantially all of the binder (for forming the image) via the image-receiving holder layer 25 may help to operate a fluid ejection device (e.g. 30 in FIGS. 1B-1C) with fewer maintenance issues because the absence (or nearly complete absence) of a binder in the droplets 72 may avoid fouling the ejection elements, which may sometimes occur with droplets 72 including binder material for forming an image on an image formation medium. In addition to simplifying maintenance, this arrangement may increase a longevity of the ejection elements (e.g. printhead) of the fluid ejection device.

In some examples, the developer unit 402 is to apply the image-receiving holder layer 25 in a volume to cover at least substantially the entire surface of the transfer member 23, 480 in at least the area in which the image is be formed on transfer member 23, 480 and immediately surrounding regions. In some examples, in this context, the term “substantially the entire” comprises at least 95 percent, while in some examples, the term “substantially the entire” comprises at least 99 percent.

In some examples, the image-receiving holder layer 25 is applied to form a uniform layer covering an entire surface of the transfer member 23, 480 (at least including the area in which an image is to be formed). This arrangement stands in sharp contrast to some liquid electrophotographic printers in which liquid ink (with color pigments) is applied just to areas of a charged photo imaging plate (PIP), which have been discharged in a pattern according to the image to be formed. According, the application of a uniform layer (covering an entire surface of the transfer member 23, 480) of the image-receiving holder layer 25 in the example image formation device (e.g. in FIGS. 6A-6B, 7A-7B) bears no particular relationship to the pattern of an image to be formed on the image-receiving holder layer 25. Therefore, in some instances, the image-receiving holder layer 25 may sometimes be referred to as a non-imaging, image-receiving holder layer 25.

Moreover, in another aspect, coating image-receiving holder layer 25 on transfer member 23 may effectively eliminate “image memory” which otherwise may sometimes occur when forming ink images directly on a transfer member. In one aspect, this elimination of “image memory” is achieved because the image-receiving holder layer 25 comprises a significantly high proportion of solids.

In addition, the coating of image-receiving holder layer 25 on the transfer member 23 may protect the transfer member 23, 480 from dust from an image formation medium (e.g. paper dust) and/or from plasma associated with production of charges 44 via the charge source 42, as further described later, and/or from any pigments or ink particles 34 which might otherwise become stuck on the transfer member 23 in the absence of the image-receiving holder layer 25. Among other aspects, this arrangement may increase a longevity of the transfer member 23, 480. In some examples, the employment of the image-receiving holder layer 25 to receive and transfer an image (made of ink particles 34) may substantially increase the longevity of the transfer member 23, 480. In some examples, in this context the term “substantially increase” may correspond to an increase in longevity of at least 25%, at least 50%, or at least 75%. In some examples, in this context the term “substantially increase” may correspond to an increase in longevity of at least 2×, at least 3×, or at least 5×.

FIG. 7A is a diagram including a side view schematically representing an example image formation device 500. It will be further understood that FIG. 7A also may be viewed as schematically representing at least some aspects of an example method of image formation.

In some examples, the image formation device 500 comprises at least some of substantially the same features and attributes as the previously described example image formation devices (e.g. 20, 200, 300) in FIGS. 1A-6C.

As shown in FIG. 7A, in some examples the image formation device 500 comprises a transfer member 23, a preliminary portion 310, a first portion 30, second portion 40, third portion 250, fourth portion 580. Operation of the image formation device 500 results in a printed medium assembly 590 as shown in FIG. 7B and which comprises an image-receiving holder layer 25 covering and bonding an image formed via ink particles 34 on an image formation medium 586. In some examples, the preliminary portion 310 and/or at least first, second, third portions (30, 40, 250) comprise at least some of substantially the same features and attributes as previously described in association with at least FIGS. 1A-6C. In some examples, the substrate 24 is implemented as a transfer member 23 which supports an image-receiving holder layer 25 having substantially the same features and attributes as image-receiving holder layer 25 described in association with FIGS. 6A-6C.

As further shown in FIG. 7A, in some examples the preliminary portion 310 of image formation device 20 is to receive a coating of material on the transfer member 23 to form an image-receiving holder layer 25 in a manner substantially the same as described in association with at least FIGS. 6A-6B.

In some examples, transfer member 23 may implemented on, or as part of, an endless belt or web (e.g. 711 in FIG. 8) while in some examples transfer member 23 may be implemented on, or as part of, a rotating drum. When implemented as an endless belt or web, it will be understood that the transfer member 23 may be moved along travel path T via support from an array of rollers (e.g. 710 in FIG. 8), tensioners, and related mechanisms to maintain tension and provide direction to transfer member 23 along travel path T.

As shown in FIG. 7A, the transfer member 23 moves along a travel path T. In some examples, the transfer member 23 comprises an electrically conductive member, among other layers. In some examples, the transfer member may be referred to as a blanket. In some examples, the electrically conductive portion of the transfer member 23 may be in contact with an electrically conductive ground element such as a brush, roller or plate in rolling or slidable contact, respectively, with a portion of the transfer member 23. In some examples, a ground element (e.g. 29 in FIG. 1A) is in contact with an edge or end of the transfer member 23. At least one example implementation of the transfer member 23 is described as transfer member 480 in FIG. 6B.

In a manner consistent with the previously-described example image formation devices, electrostatic fixation (EF) and/or molecular fixation (MF) of ink particles 34 occurs relative to the image-receiving holder layer 25, thereby ensuring that the ink particles 34 remain in their targeted locations to form an image. In one aspect, the electrostatic fixation (EF) and/or molecular fixation (BF) occurs relative to the charged binder material in the image-receiving holder layer 25. Accordingly, while the EF and MF arrows are omitted in FIG. 7A for illustrative simplicity, it will be understood that such electrostatic forces (EF) and molecular forces (MF) are present in the second, third, etc. portions of the image formation device 500 as previously described in association with at least FIGS. 1A-6C. FIG. 7C depicts charged color ink particles 34 being electrostatically fixed (EF) and molecularly fixed (MF) relative to an image-receiving holder layer 625 (like 25 in FIGS. 6A-7B) supported by transfer member 623. In some examples, image-receiving holder layer 625 may be compliant enough to increase a contact area of the ink particles 34 with the image-receiving holder layer 625 as represented by the partial penetration of portions of the ink particle 34 within the surface of the image-receiving holder layer in FIG. 7C. This arrangement may increase the distance-dependent, molecular attractive forces (MF) of the ink particle(s) 34.

As further shown in FIG. 7A, in some examples image formation device 500 may further comprise a transfer station 582 (in fourth portion 580) downstream from at least the liquid removal element 252 (in third portion 250). Via at least a transfer roller (e.g. drum) 604 the transfer station 582 is to transfer at least substantially the entire image-receiving holder layer 25 with at least substantially the entire volume of ink particles 34 thereon (in the form of an image) onto an image formation medium 586. As previously noted, this complete (or nearly complete transfer) may increase image quality, protect the transfer member, etc. In addition, in this way, no residue is left remaining on the transfer member 23, 480, thereby simplifying or eliminating later cleaning of the transfer member 23, 480, such as between consecutive printing episodes.

In some examples, the transfer station 582 may employ heat, pressure, and/or electrical bias, etc. in order to effect the above-described transfer.

In addition, by transferring the image-receiving holder layer 25 with the ink particles 34 (as a pattern or form of an image), the image-receiving holder layer 25 becomes an outermost layer of a completed image formation medium assembly 590 shown in FIG. 7B, thereby protecting the image formed of ink particles 34 and helping bond the formed image to the image formation medium 586.

In some examples, the image-receiving holder layer 25 may sometimes be referred to as an image receiver or an image holder. In some examples, the image-receiving holder layer 25 may sometimes be referred to as an initial image formation medium (i.e. initial print medium) because the image is formed on, and remains on, the image-receiving holder layer 25. Meanwhile, the “medium” (e.g. 586 in FIGS. 7A-7B) to which the ink particles and the image-receiving holder layer 25 are transferred together (via a transfer station) may sometimes be referred to as a second image formation medium (i.e. second print medium) or a final image formation medium (i.e. final print medium). In some examples, the initial image formation medium (e.g. 25 in FIG. 7A) and the final image formation medium (e.g. 586 in FIG. 7B) may sometimes be referred to as a first image formation medium and a second image formation medium, respectively. In some such examples, the second or final image formation medium is part of an image formation medium assembly (e.g. 590 in FIG. 7B) in which the image made of a pattern(s) of ink particles 34 are at least partially sandwiched between the initial (or first) image formation medium 25 (e.g. image-receiving holder layer) and the final (or second) image formation medium 586. In some such examples, the image formed of a pattern(s) of ink particles 34 becomes at least partially sandwiched between the first and second image formation mediums with some portions of the respective first and second image formation mediums (e.g. 25, 586) being in direct contact with each other, as shown in FIG. 7B in one example.

In some examples, the second image formation medium may sometimes be referred to as a cover layer or outer layer relative to the ink particles and relative to the first image formation medium (i.e. image-receiving holder).

In some examples, the image-receiving holder may sometimes be referred to as an image-receiving medium. In some examples, the semi-liquid image-receiving holder may sometimes be referred to as a paste, a semi-liquid base, semi-solid base, or base layer.

In transferring all or substantially all of the ink particles 34 (from their supported position relative to transfer member 23) onto an image formation medium 586, the image-receiving holder layer 25 facilitates additional forms of printing, i.e. image formation. In particular, because all of the ink particles 34 can be transferred, the fluid ejection device (e.g. 70 in FIGS. 10, 3) (via instructions from control portion 1000) can perform stochastic-screening image formation via ink particles in which dot sizes (made of ink particles 34) used to form an image may be less than 50 microns on the image-receiving holder layer 25 (supported by the transfer member 23). In some such examples, the dot sizes formed on the image-receiving holder layer 25 may be about 40 microns or less than 40 microns, may be about 30 microns or less, etc. In some such examples, the dot sizes formed on the image-receiving holder layer 25 may be about 20 microns or less. It will be understood that in some examples the ink particles 34 may have a largest dimension (e.g. diameter, length, etc.) less than about 1 micron.

In some instances, the stochastic screening may sometimes be referred to as frequency modulation (FM) screening. In some examples, the stochastic screening may comprise printing according to a pseudo-random distribution of halftone dots in which frequency modulation (FM) is used to control the density of dots according to the gray level desired. Via such stochastic screening, the fluid ejection device (e.g. 70 in FIGS. 10, 3) deposits a fixed size of dots (e.g. on the order of 20 microns in just one example) and implements a distribution density that varies depending on the color's tone. In contrast, in amplitude modulation (AM) halftone printing the printed dots may vary in size depending on the color tone being represented, while maintaining a geometric and fixed spacing of the dots. However, in amplitude modulation halftone printing the minimum size of the printed dots is substantially greater (e.g. 50%, 75%, 100%) greater than a size of dots printable via stochastic screening, such as available via the example image formation device 500.

Via stochastic screening in some examples, the example image formation device 500 may produce higher resolution images on an image formation medium, enable use of a greater color gamut, among other aspects.

FIG. 8 is a diagram including a side view schematically representing at least a portion of an example image formation device 700. In some examples, image formation device 700 comprises at least some of substantially the same features as the image formation devices as previously described in association with FIGS. 1A-7C. In examples, image formation device 700 also comprises a substrate 24 or related transfer member (e.g. 23, 480) arranged in the form of, or as part of, an endless belt or web 711 and with the various portions 310, 30, 40, 250, 260, etc. of image formation device 700 arranged in a pattern along belt 711 which travels in an endless loop, as shown in FIG. 8. For illustrative simplicity, the various portions 310, 30, 40, 250, 260, etc. of image formation device 700 are represented via boxes instead of dashed lines as in FIG. 1A and FIGS. 3, 5, 7A, 9.

In some examples, transfer belt 711 forms part of a belt assembly 710 including various rollers 712, 714, 716, 718, 720, etc. and related mechanisms to guide and support travel of belt 711 along travel path T and through the various portions 310, 30, 40, 250, 260, etc. of image formation device 700.

In a manner similar to that previously described for image formation device 20, the various portions 310, 30, 40, 250, 260, etc. operate as previously described in association with FIGS. 1A-7C to form an image on an image formation medium 746, including the previously described electrostatic fixation and/or molecular fixation of ink particles 34 relative to a substrate (e.g. transfer member 711 in FIG. 8). As further shown in FIG. 8, in some examples the image formation device 700 comprise a fifth portion 580, which may comprise a transfer station 760 comprising at least some of substantially the same features and attributes as the previously described transfer station (e.g. 582 in FIG. 7A). In some instances, the roller 720 may serve as, or be referred to, as an impression cylinder.

FIG. 9 is a diagram including a side view schematically representing at least a portion of an example image formation device 800. In some examples, the image formation device 800 comprises a substrate 24 and a series of stations 810, 820, etc. arranged along the travel path T of the substrate 24 in which each station is to provide one color ink of a plurality of different color inks onto the substrate, transfer member, etc. It will be further understood that FIG. 9 also may be viewed as schematically representing at least some aspects of an example method of image formation.

In some examples, the image formation device 800 comprises at least some of substantially the same features and attributes as the image formation devices 20, 200, 300, 500, 700, as previously described in association with FIGS. 1A-8. However, in image formation device 800 a series of image formation stations 810, 820 etc. is provided along a travel path T of the substrate 24. It will be understood that the image formation device 800 can be implemented with the substrate 24 (or underlying transfer member 23) as a belt (FIG. 8) or as a drum, and the various first, second stations (each including first, second portions, etc.) appropriately arranged to such configuration.

Each different image formation station 810, 820, etc. provides for at least partial formation of an image on the substrate 24 by a respectively different color ink. Stated differently, the different stations apply different color inks such that a composite of the differently colored applied inks forms a complete image on the substrate 24 as desired. In some examples, the different color inks correspond to the different colors of a color separation scheme, such as Cyan (C), Magenta (M), Yellow (Y), and black (K) wherein each different color is applied separately as a layer to the substrate 24 as substrate 24 moves along travel path T.

As shown in FIG. 9, each station 810, 820, etc. may comprise at least a first portion 30 and a second portion 40 having substantially the same features as previously described. In some examples, each station may comprise additional portions as described in association with at least FIGS. 1A-8.

Accordingly, upon the completion of each respective station (e.g. 810, 820), a layer of ink particles 34 will be fixed to the substrate 24, such that later stations will add additional layers of ink particles 34 (of different colors) onto the previous layer(s) of fixed ink particles 34. It will be understood that, for illustrative simplicity, station 820 in FIG. 9 omits depiction of a previously deposited, fixed layer of ink particles from station 810.

In a manner consistent with the previously-described example image formation devices, in some examples the image formation device 800 is to cause electrostatic fixation and/or molecular fixation of ink particles 34 relative to the substrate 24, thereby ensuring that the ink particles 34 remain in their targeted locations to form a high quality image. Accordingly, while FIG. 9 omits depicting the electrostatic force (EF) and molecular force (MF) arrows previously shown in FIGS. 1A, 2B-2C, it will be understood that such forces are present in the second, third, etc. portions of the image formation device 800.

As further shown in FIG. 9, the image formation device 800 may comprise additional stations, and as such, the black circles III, IV represent further stations like stations 810, 820 for applying additional different color inks onto a substrate 24. In some examples, the additional stations may comprise a fewer number or a greater number of additional stations (e.g. III, IV) than shown in FIG. 9.

In some examples, each station 810, 820, etc. of image formation device 800 can include its own liquid removal element (e.g. 252 in FIG. 3).

However, in some examples, image formation device 800 comprises just one third portion 250 (including at least one liquid removal element 252) which is located downstream from multiple color stations 810, 820, etc. such that the cumulative excess liquid (from printing at those stations) is removed all at once. Stated differently, each of the respective color stations 810, 820 omit a liquid removal element (e.g. 252) and liquid removal does not take place until after the last color station in the series of color stations 810, 820, etc.

In some examples, the image formation device 800 may comprise at least one second liquid removal unit 262 (FIG. 3), such as a dryer or other implementation of an energy transfer mechanism (e.g. 264 in FIG. 4B, 730 in FIG. 8) downstream from the multiple color stations 810, 820, with the second liquid removal unit 262 being downstream along the travel path T from the last liquid removal element 252 (e.g. FIGS. 3, 5, 7A) at the end of the multiple color stations 810, 820, etc.

In some examples, the image formation device 800 also may comprise a fifth portion downstream from the multiple stations 810, 820, etc. and which comprises a transfer station comprising at least some of substantially the same features and attributes as transfer station 582 in FIG. 7A, 760 in FIG. 8, etc.

In a manner at least substantially the same as in the examples in FIGS. 5-7A, in some examples the image formation device 800 may comprise a preliminary portion 310 may located upstream from the series of stations 810, 820 in order to provide a primer layer P (e.g. FIG. 5) or an image-receiving holder layer 25 (e.g. FIG. 6A-7B) on a transfer member 23.

FIG. 10 is a block diagram schematically representing an example control portion 1000. In some examples, control portion 1000 provides one example implementation of a control portion forming a part of, implementing, and/or generally managing the example image formation devices (e.g. 20, 200, 300, 500, 700, 800) as well as the particular stations, portions, elements, devices, user interface, instructions, engines, and/or methods, as described throughout examples of the present disclosure in association with FIGS. 1A-9 and 11-12.

In some examples, control portion 1000 includes a controller 1002 and a memory 1010. In general terms, controller 1002 of control portion 1000 comprises at least one processor 1004 and associated memories. The controller 1002 is electrically couplable to, and in communication with, memory 1010 to generate control signals to direct operation of at least some the image formation devices, various portions, stations, devices, and/or elements of the image formation devices, such as but not limited to, developer units, fluid ejection devices, charge sources, liquid removal portions, liquid removal, dryers, transfer stations, user interfaces, instructions, engines, functions, and/or methods, as described throughout examples of the present disclosure. In some examples, these generated control signals include, but are not limited to, employing instructions 1011 stored in memory 1010 to at least direct and manage developing an image-receiving holder layer onto a transfer member, depositing droplets of ink particles and carrier fluid to form an image on a media, directing charges onto ink particles via a particular polarity and/or at a particular charge intensity, removing liquids, transferring ink and the image-receiving holder layer (or a primer layer) onto an image formation medium, etc. as described throughout the examples of the present disclosure in association with FIGS. 1A-9 and 11-12. In some instances, the controller 1002 or control portion 1000 may sometimes be referred to as being programmed to perform the above-identified actions, functions, etc. In some examples, at least some of the stored instructions 1011 are implemented as, or may be referred to as, a print engine or image formation engine.

In response to or based upon commands received via a user interface (e.g. user interface 1020 in FIG. 11) and/or via machine readable instructions, controller 1002 generates control signals as described above in accordance with at least some of the examples of the present disclosure. In some examples, controller 1002 is embodied in a general purpose computing device while in some examples, controller 1002 is incorporated into or associated with at least some of the image formation devices, portions, stations, and/or elements along the travel path, developer units, fluid ejection devices, charge sources, liquid removal portions, liquid removal, dryers, transfer stations, user interfaces, instructions, engines, functions, and/or methods, etc. as described throughout examples of the present disclosure.

For purposes of this application, in reference to the controller 1002, the term “processor” shall mean a presently developed or future developed processor (or processing resources) that executes sequences of machine readable instructions contained in a memory. In some examples, execution of the sequences of machine readable instructions, such as those provided via memory 1010 of control portion 1000 cause the processor to perform the above-identified actions, such as operating controller 1002 to implement the formation of an image as generally described in (or consistent with) at least some examples of the present disclosure. The machine readable instructions may be loaded in a random access memory (RAM) for execution by the processor from their stored location in a read only memory (ROM), a mass storage device, or some other persistent storage (e.g., non-transitory tangible medium or non-volatile tangible medium), as represented by memory 1010. In some examples, memory 1010 comprises a computer readable tangible medium providing non-volatile storage of the machine readable instructions executable by a process of controller 1002. In other examples, hard wired circuitry may be used in place of or in combination with machine readable instructions to implement the functions described. For example, controller 1002 may be embodied as part of at least one application-specific integrated circuit (ASIC). In at least some examples, the controller 1002 is not limited to any specific combination of hardware circuitry and machine readable instructions, nor limited to any particular source for the machine readable instructions executed by the controller 1002.

In some examples, control portion 1000 may be entirely implemented within or by a stand-alone device.

In some examples, the control portion 1000 may be partially implemented in one of the image formation devices and partially implemented in a computing resource separate from, and independent of, the image formation devices but in communication with the image formation devices. For instance, in some examples control portion 1000 may be implemented via a server accessible via the cloud and/or other network pathways. In some examples, the control portion 1000 may be distributed or apportioned among multiple devices or resources such as among a server, an image formation device, and/or a user interface.

In some examples, control portion 1000 includes, and/or is in communication with, a user interface 1020 as shown in FIG. 11. In some examples, user interface 1020 comprises a user interface or other display that provides for the simultaneous display, activation, and/or operation of at least some of the image formation devices, stations, portions, elements, user interfaces, instructions, engines, functions, and/or methods, etc. as described in association with FIGS. 1-10 and 12. In some examples, at least some portions or aspects of the user interface 1020 are provided via a graphical user interface (GUI), and may comprise a display 1024 and input 1022.

FIG. 12 is a flow diagram schematically representing an example method. In some examples, method 1100 may be performed via at least some of the same or substantially the same devices, portions, stations, elements, control portion, user interface, methods, etc. as previously described in association with FIGS. 1A-11. In some examples, method 1100 may be performed via at least some devices, portions, stations, elements, control portion, user interface, methods, etc. other than those previously described in association with FIGS. 1A-11.

As shown at 1102 of FIG. 12, in some examples method 1100 comprises forming an image on a substrate, moving along a travel path, via ejecting droplets of color ink particles within a dielectric, non-aqueous carrier fluid onto the substrate. In some examples, the conductivity of the ink particles may comprise at least about 500 pS/cm or may comprise one of the earlier described conductivities. In some examples, the conductivity comprises at least one order of magnitude greater than a conductivity of 100 pS/cm. As shown at 1104, in some examples method 1100 comprises electrostatically fixing, downstream from the forming, the color ink particles relative to the substrate via directing airborne charges to charge the color ink particles to induce movement of the charged color ink particles, via electrostatic attraction relative to the substrate, through the carrier fluid to and against the substrate. As shown at 1108, in some examples method 1100 comprises additionally fixing the color ink particles, in their electrostatically fixed position, relative to the substrate via distance-dependent, molecular forces and for a duration at least greater than a duration of the electrostatic fixation.

It will be understood that in some examples the molecular fixation may be initiated and performed in generally the same time frame as at least initiation of the electrostatic fixation. In some examples, the distance-dependent, molecular fixation may be initiated and performed at a point in time after the initial electrostatic fixation of the ink particles against the substrate, but while the electrostatic fixation remains sufficiently strong to hold the ink particles against the substrate in their respective positions (i.e. in their electrostatically pinned positions) at least until the distance-dependent molecular fixation is implemented and sufficiently strong to hold the ink particles in their electrostatically fixed positions.

Although specific examples have been illustrated and described herein, a variety of alternate and/or equivalent implementations may be substituted for the specific examples shown and described without departing from the scope of the present disclosure. This application is intended to cover any adaptations or variations of the specific examples discussed herein.

1. An image formation device comprising:
a first portion to receive droplets of color ink particles within a dielectric carrier fluid onto a substrate to form an image; and
a second portion comprising a charge source to emit airborne charges in a first predetermined intensity to charge the ink particles to move, via electrostatic attraction relative to the substrate, through the carrier fluid to become at least electrostatically fixed relative to the substrate and to become additionally fixed via distance-dependent, molecular forces, in the electrostatically fixed position, via at least a binder material relative to the substrate and for a duration at least greater than a duration of the electrostatic fixation,
wherein the binder material is to become active without receiving heat or radiation.

2. The device of claim 1, wherein the first predetermined intensity is at least about 50 nC/cm².

3. The device of claim 2, wherein the binder material is from at least one of the ink particles, the carrier fluid, and the substrate, and
wherein the binder material comprises about 15 percent to about 35 percent weight resin, the resin comprising at least one of ethylene acid copolymers and ethylene vinyl acetate copolymers.

4. The device of claim 1, wherein based on the first predetermined intensity of airborne charges and based on activity of the binder material, the electrostatic forces are to cause at least some of the ink particles and the substrate to become electrostatically attracted to each other within a distance less than about 1 nanometer to at least partially implement the additional fixation of ink particles via the distance-dependent, molecular forces.

5. The device of claim 1, the color ink particles having a conductivity of at least 500 pS/cm.

6. The device of claim 1, comprising:
a transfer member to travel along the travel path, wherein the substrate comprises a primer layer, an image formation medium, or a top layer of the transfer member, and wherein the transfer member is to support the primer layer or the image formation medium when the substrate comprises the primer layer or the image formation medium.

7. The device of claim 6, wherein the substrate comprises the primer layer and the device comprises a preliminary portion upstream from the first portion to receive the primer layer as the substrate on the transfer member, and the primer layer comprises at least some of the binder material.

8. The device of claim 1, comprising:
a third portion upstream along the travel path from the first portion and comprising a developer unit to apply an electrically charged, semi-liquid image-receiving holder layer as the substrate on a transfer member, wherein the image-receiving holder comprises at least some of the binder material and a charge director additive material to at least partially implement the electrostatic fixation and the addition fixation of the charged color ink particles relative to the image-receiving holder layer.

9. A device comprising:
a control portion;
a series of stations arranged along a travel path of a substrate which each station is to provide one color ink of a plurality of different color inks onto the substrate, and wherein each station comprises:
a first portion along the travel path, which via operation of the control portion, is to receive droplets of color ink particles within a dielectric carrier fluid onto a substrate to form an image, the ink particles comprising a conductivity of at least 500 pS/cm;
a second portion comprising a charge source to emit airborne charges in a first predetermined intensity to charge the ink particles to move, via electrostatic attraction relative to the substrate, through the carrier fluid to become at least electrostatically fixed relative to the substrate and to become additionally fixed via distance-dependent, molecular forces, in the electrostatically fixed position, via at least a binder material relative to the substrate and for a duration at least greater than a duration of the electrostatic fixation,
wherein the binder material is to become active without receiving heat or radiation and wherein the binder material is from at least one of the ink particles, the carrier fluid, and the substrate.

10. The device of claim 9, comprising:
a transfer member to travel along the travel path, wherein the substrate comprises a primer layer, an image formation medium, or a top layer of the transfer member, and wherein the transfer member is to support the primer layer or the image formation medium when the substrate comprises the primer layer or the image formation medium.

11. The device of claim 9, comprising:
a third portion upstream along the travel path from the first portion and comprising a developer unit to apply an electrically charged, semi-liquid image-receiving holder layer as the substrate on a transfer member, wherein the image-receiving holder comprises at least some of the binder material and a charge director additive material to at least partially implement the electrostatic fixation and the addition fixation, via the distance-dependent molecular forces, of the charged color ink particles relative to the electrically charged, semi-liquid image-receiving holder layer.

12. A method comprising:
forming an image on a substrate, moving along a travel path, via ejecting droplets of color ink particles within a dielectric, non-aqueous carrier fluid in a selected pattern onto the substrate; and
downstream from the forming, electrostatically fixing the color ink particles relative to the substrate via directing airborne charges in a first predetermined intensity to charge the color ink particles to induce movement of the charged color ink particles, via electrostatic attraction relative to the substrate, through the carrier fluid to and against the substrate; and
additionally fixing the color ink particles, in the electrostatically fixed position, relative to the substrate via distance-dependent, molecular forces between the substrate and the charged ink particles and for a duration at least greater than a duration of the electrostatic fixation.

13. The method of claim 12, comprising implementing the directing of the airborne charges with the first predetermined intensity of at least 50 nC/cm².

14. The method of claim 12, comprising:
at least partially implementing the electrostatic fixation and the additional fixation via distance-dependent, molecular forces by providing a binder material via at least one of the substrate, the ink particles, and the dielectric carrier fluid, including arranging the binder material to become active without heating or radiation.

15. The method of claim 12, the color ink particles having a conductivity of at least 500 pS/cm.
